(19) United States
(12) Patent Application Publication
(10) Pub. No.: US 2013/0093348 A1
(43) Pub. Date: Apr. 18, 2013

(54) METHOD, APPARATUS AND SYSTEM FOR CONTROLLING LIGHT SOURCE

(71) Applicants: Liang'an Ge, Hangzhou (CN); Xiaoli Yao, Hangzhou (CN); Guichao Hua, Hangzhou (CN); Lijun Ren, Hangzhou (CN)

(72) Inventors: Liang'an Ge, Hangzhou (CN); Xiaoli Yao, Hangzhou (CN); Guichao Hua, Hangzhou (CN); Lijun Ren, Hangzhou (CN)

(73) Assignee: INVENTRONICS (HANGZHOU), INC., Hangzhou, Zhejiang (CN)

(21) Appl. No.: 13/806,413

(22) PCT Filed: Nov. 12, 2010
(86) PCT No.: PCT/CN2010/078686

§ 371 Date: Dec. 21, 2012

(30) Foreign Application Priority Data
Jun. 22, 2010 (CN) 201010213828.7

(51) Int. Cl. H05B 37/02

(52) U.S. Cl. CPC H05B 37/02
USPC 315/224

(57) ABSTRACT

A method, an apparatus and a system for controlling a light source are disclosed. The method comprises: receiving a dimming command, determining the dimming item specified by the dimming command (201); determining the corresponding chopping type and/or the range of the chopping phase angle according to the dimming item (202); and controlling the regulation switch according to the determined chopping type and/or the range of the chopping phase angle in order to output the voltage containing a chopping voltage (203). The method, the apparatus and the system can achieve the regulation functions for the light source color and/or the luminance etc.

This application claims the benefit of Chinese patent application No. 201010213828.7, titled “METHOD, APPARATUS AND SYSTEM FOR CONTROLLING LIGHT SOURCE” and filed with the State Intellectual Property Office on Jun. 22, 2010, which is hereby incorporated by reference in its entirety.

### FIELD OF THE INVENTION

The present invention relates to the field of control, and in particular to a method, an apparatus and a system for controlling a light source.

### BACKGROUND OF THE INVENTION

In the field of lighting, the luminance or color of a light source needs to be adjusted on various occasions, which requires the lighting system to be provided with an adjustment function.

Currently, one of the popular techniques is chopping-based light adjusting. FIG. 1 illustrates the circuit structure of a light source adjustor, including a bidirectional trigger diode D1 used as an adjusting switch, and a trigger circuit consisting of an adjustable resistor R1 and a first capacitor C1.

The operating principle of the light source adjustor is described as follows. The output voltage V1 of the light source adjustor is an alternating current (AC) power supply voltage when the bidirectional trigger diode D1 is turned on; the output voltage V1 of the light source adjustor is zero when the bidirectional trigger diode D1 is turned off. The first capacitor C1 is charged through the adjustable resistor R1; and when the voltage across the first capacitor C1 rises to the turn-on voltage of the bidirectional trigger diode D1, the bidirectional trigger diode D1 is turned on. Therefore, changing the resistance of the adjustable resistor R1 will change the charging time of the first capacitor C1; then, the change of the charging time will change the conducting angle of the bidirectional trigger diode D1, which is reflected by the output voltage V1 of the light source adjustor, resulting in a chopped voltage such as the leading-edge chopped voltage as shown in FIG. 1a. The chopped voltage is outputted to a subsequent driver for driving a light source, and the luminance of the light source is adjusted via the driver.

The chopping-based light adjusting technique described above can only adjust the luminance of a light source in a hardware manner, but cannot realize other adjustment functions at the same time such as changing the color of the light source in a, e.g., colored lighting system.

### SUMMARY OF THE INVENTION

In view of the above, a technical problem to be solved by the present invention is to provide a method and a system for controlling a light source, which can achieve the adjustment of, e.g., color and/or luminance, of the light source.

Therefore, the following technical solutions are provided by the embodiments of the present invention.

According to an embodiment of the present invention, it is provided a method for controlling a light source, including:

receiving a light-adjusting instruction, and determining a light-adjusting item instructed by the light-adjusting instruction;

determining, according to the light-adjusting item, a chopping type and/or a range for a chopping phase angle corresponding to the light-adjusting item; and
controlling an adjusting switch according to the chopping type and/or the range for the chopping phase angle, so as to output electric energy including a chopped voltage.

The determining the chopping type and/or the range for the chopping phase angle corresponding to the light-adjusting item according to the light-adjusting item may include:

presetting a correspondence relationship between the chopping type and/or the range for the chopping phase angle and the light-adjusting item; and

searching, according to the light-adjusting item, the correspondence relationship for the chopping type and/or the range for the chopping phase angle corresponding to the light-adjusting item.

The controlling the adjusting switch according to the chopping type and/or the range for the chopping phase angle may include:

determining a phase angle control strategy of the adjusting switch according to the chopping type and/or the range for the chopping phase angle; and

controlling the adjusting switch according to the phase angle control strategy.

The controlling the adjusting switch may include: performing chopping-based control on the adjusting switch for a time period mT within a time period NT after receiving the light-adjusting instruction, where mT<NT; m is a preset constant; T is the period of an alternating current (AC) power supply; and NT is a time interval between receiving the current light-adjusting instruction and receiving the next light-adjusting instruction, or is a preset period of chopping-based control.

The method may further include: controlling the adjusting switch to be turned on during the rest of the time period NT, other than the time period mT, after receiving the light-adjusting instruction.

The light-adjusting item may include: adjustment to color and/or luminance, and/or a level of the adjustment to luminance.

According to an embodiment of the present invention, it is provided a method for controlling a light source, including:

receiving electric energy including a chopped voltage, and detecting a chopping type and/or a range for a chopping phase angle of the chopped voltage;

determining a light-adjusting item according to the chopping type and/or the range for the chopping phase angle;

controlling the light source according to the light-adjusting item.

The controlling the light source according to the light-adjusting item may include:

determining an output current according to the light-adjusting item;

generating a corresponding current output to the light source, so as to control the light source as instructed by the light-adjusting item.

The light-adjusting item may include: adjustment to color and/or luminance, and/or a level of the adjustment to luminance.

According to an embodiment of the present invention, it is provided an apparatus for controlling a light source, including:

a first receiving unit, for receiving a light-adjusting instruction and determining a light-adjusting item instructed by the light-adjusting instruction;

a first determination unit, for determining according to the light-adjusting item a chopping type and/or a range for a chopping phase angle corresponding to the light-adjusting item;

a first control unit, for controlling an adjustment switch according to the chopping type and/or the range for the chopping phase angle, so as to output electric energy including a chopped voltage.

The first determination unit may include:

a relationship storage sub-unit, for storing a preset correspondence relationship between the chopping type and/or the range for the chopping phase angle and the light-adjusting item; and

a searching sub-unit, for searching, according to the light-adjusting item, the correspondence relationship for the chopping type and/or the range for the chopping phase angle corresponding to the light-adjusting item.

The first control unit may include:

a first determination sub-unit, for determining a phase angle control strategy of the adjusting switch according to the chopping type and/or the range for the chopping phase angle;

a control sub-unit, for controlling the adjusting switch according to the phase angle control strategy.

Specifically, the first control unit may be used for: performing chopping-based control on the adjusting switch for a time period mT within a time period NT after receiving the light-adjusting instruction, where mT<NT; m is a preset constant; T is the period of an alternating current (AC) power supply; and NT is a time interval between receiving the current light-adjusting instruction and receiving the next light-adjusting instruction, or is a preset period of chopping-based control.

The first control unit may further be used for:

controlling the adjusting switch to be turned on during the rest of the time period NT, other than the time period mT, after receiving the light-adjusting instruction.

The light-adjusting item may include: adjustment to color and/or luminance, and/or a level of the adjustment to luminance.

According to an embodiment of the present invention, it is provided an apparatus for controlling a light source, including:

a second receiving unit, for receiving electric energy including a chopped voltage, and detecting a chopping type and/or a range for a chopping phase angle of the chopped voltage;

a second determination unit, for determining a light-adjusting item according to the chopping type and/or the range for the chopping phase angle;

a second control unit, for controlling the light source according to the light-adjusting item.

The second control unit may include:

a second determination sub-unit, for determining an output current according to the light-adjusting item;

a generation sub-unit, for generating a corresponding current output to the light source, so as to control the light source as instructed by the light-adjusting item.

The light-adjusting item may include: adjustment to color and/or luminance, and/or a level of the adjustment to luminance.

According to an embodiment of the present invention, it is provided a system for controlling a light source, including:

a light source adjustor, for receiving a light-adjusting instruction, and determining a light-adjusting item instructed by the light-adjusting instruction; determining, according to the light-adjusting item, a chopping type and/or a range for a chopping phase angle corresponding to the light-adjusting item; and controlling an adjusting switch according to the chopping type and/or the range for the chopping phase angle, so as to output electric energy including a chopped voltage;

a driver, for receiving the electric energy including the chopped voltage, detecting the chopping type and/or the range for the chopping phase angle of the chopped voltage; determining the light-adjusting item according to the chopping type and/or the range for the chopping phase angle; and controlling the light source according to the light-adjusting item.

The technical effects of the above technical solutions are discussed below:

The corresponding chopping type and/or the range for the chopping phase angle are determined according to the light-adjusting item instructed by the light-adjusting instruction, and the adjusting switch is controlled according to the chopping type and/or the range for the chopping phase angle, so that a chopped voltage is included in the electric energy outputted from the light source adjustor. Then, the light-adjusting item is instructed to the driver via the chopped voltage, which facilitates the driver controlling the light source on its color and/or luminance as instructed by the light-adjusting item.

### BRIEF DESCRIPTION OF THE DRAWINGS

FIG. 1 is a structural diagram of the circuit of a light source adjustor in the prior art;

FIG. 1a is a schematic diagram of the waveform of a leading-edge chopped voltage in the prior art;

FIG. 2 is a schematic flowchart of a method for controlling a light source according to an embodiment of the present invention;

FIG. 3 is a schematic flowchart of another method for controlling a light source according to an embodiment of the present invention;

FIG. 3a-3d illustrates chopped voltages generated by a light source adjustor according to an embodiment of the present invention;

FIG. 4 is a schematic flowchart of a third method for controlling a light source according to an embodiment of the present invention;

FIG. 5 is a schematic structural diagram of an apparatus for controlling a light source according to an embodiment of the present invention;

FIG. 6 is a schematic structural diagram of another apparatus for controlling a light source according to an embodiment of the present invention.

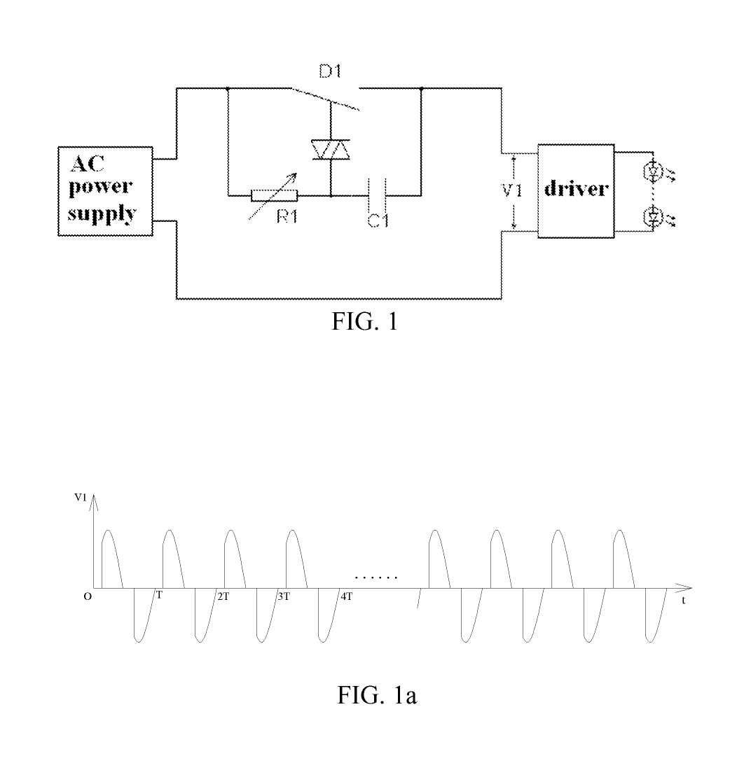

### DETAILED DESCRIPTION OF THE EMBODIMENTS

Implementations of the methods and systems for controlling a light source according to the embodiments of the present invention will be described hereinafter in detail in conjunction with the accompanying drawings.

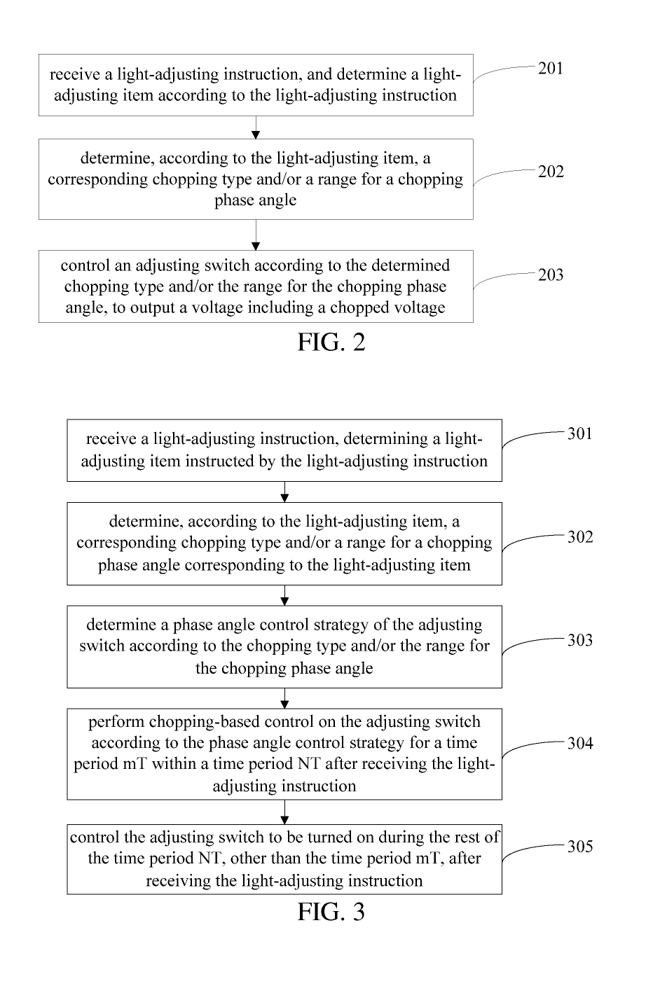

FIG. 2 is a schematic flowchart of a method for controlling a light source according to an embodiment of the present invention. The method for controlling a light source can be applied to a light source adjustor, controlling an adjusting switch in the light source adjustor. As shown in FIG. 2, the method includes:

step 201: receiving a light-adjusting instruction, and determining a light-adjusting item instructed by the light-adjusting instruction;

step 202: determining, according to the light-adjusting item, a chopping type and/or a range for a chopping phase angle corresponding to the light-adjusting item; and

step 203: controlling an adjusting switch according to the chopping type and/or the range for the chopping phase angle, so as to output electric energy including a chopped voltage.

In the method for controlling a light source shown in FIG. 2, the corresponding chopping type and/or the range for the chopping phase angle are determined according to the light-adjusting item instructed by the light-adjusting instruction, and the adjusting switch is controlled according to the chopping type and/or the range for the chopping phase angle, so that a chopped voltage is included in the electric energy outputted from the light source adjustor; then, the light-adjusting item is instructed to the driver via the chopped voltage, which facilitates the driver controlling the light source on its color and/or luminance as instructed by the light-adjusting item.

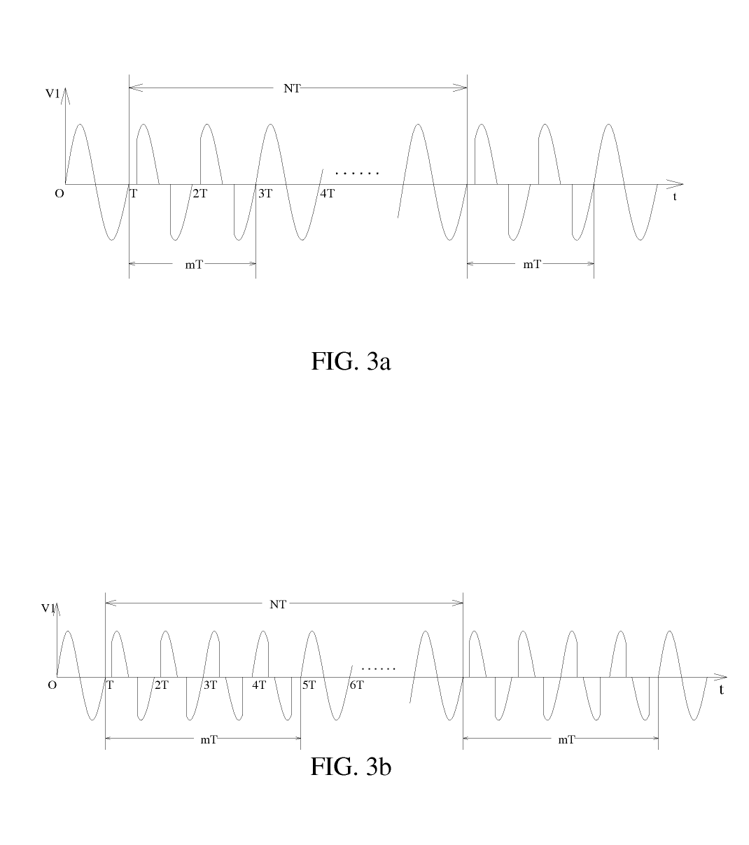

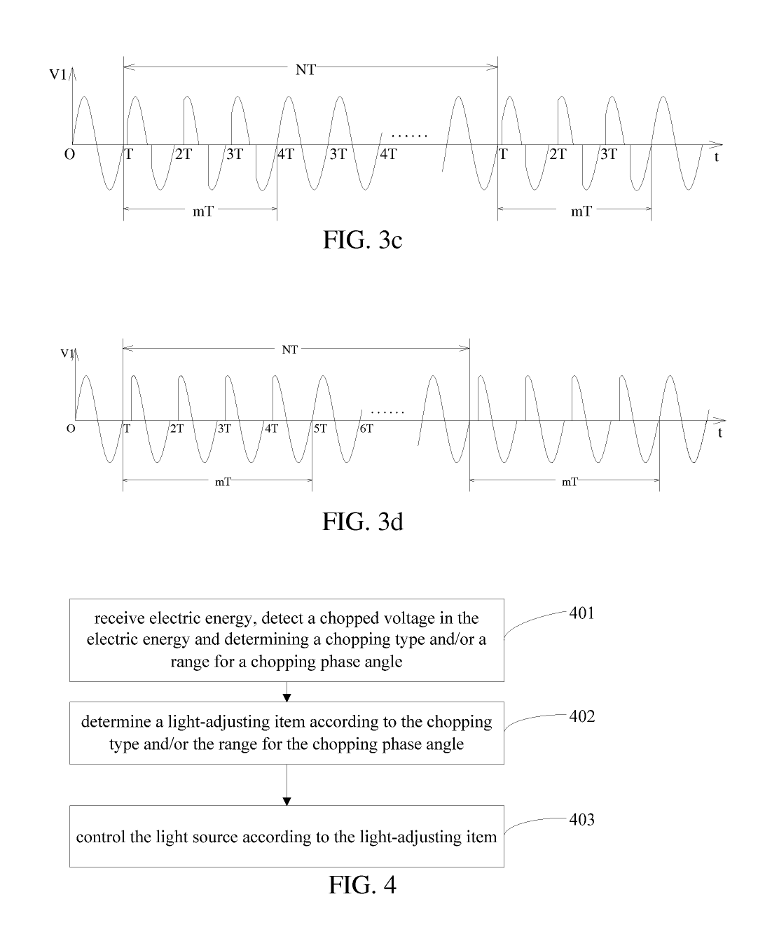

On the basis of FIG. 2, a method for controlling a light source according to an embodiment of the present invention is described in more detail with reference to FIG. 3. As shown in FIG. 3, the method includes the following steps.

Step 301: receiving a light-adjusting instruction and determining a light-adjusting item instructed by the light-adjusting instruction.

The light source may be one or more incandescent lamps, one or more LEDs, etc. The light-adjusting item may include: adjustment to luminance, or adjustment to color, or adjustment to both luminance and color; moreover, the color may be differentiated into different colors, and the luminance may be differentiated into, e.g., different levels.

The light-adjusting instruction may be a digital instruction. The digital instruction may be converted from an analog instruction, or may be inputted by a user through a human-machine interface such as a keyboard and a touchscreen, or may be a preset internal instruction.

Specifically, different light-adjusting items may be assigned with different identifiers, so that when a user designates a light source and a corresponding light-adjusting item, the light-adjusting instruction can be generated directly according to a light source identifier and a light-adjusting item identifier.

For example, the identifier for a first-level luminance is 11, the identifier for a second-level luminance is 12, the identifier for the color red is 21, the identifier for the color blue is 22, etc. And the light-adjusting instruction may be identified in a two-dimensional manner, e.g., (color, luminance). Clearly, in a practical application where only one of color and luminance is to be adjusted, the undesignated item in the light-adjusting instruction may have a default value; alternatively, the light-adjusting instruction may be represented in a one-dimensional manner, e.g., (luminance), or (color). Detailed description is omitted here.

Step 302: determining, according to the light-adjusting item, a chopping type and/or a range for a chopping phase angle corresponding to the light-adjusting item.

In a specific implementation, a correspondence relationship between different light-adjusting items and different chopping types and/or ranges for the chopping phase angle may be set in advance; then, in this step, by searching the correspondence relationship according to the light-adjusting item, the chopping type and/or the range for the chopping phase angle corresponding to the light-adjusting item can be determined. The chopping type may include: leading-edge chopping, trailing-edge chopping, leading-edge plus trailing-edge chopping, and so forth. The phase angle may range from 0° to 180°.

Specifically:

(1) light-adjusting items may be differentiated according to the chopping type, and in this case,

a correspondence relationship between chopping types and light-adjusting items may be preset, e.g., color adjustment corresponds to leading-edge chopping, light-adjusting items for luminance adjustment correspond to trailing-edge chopping.

(2) light-adjusting items may be differentiated by different ranges for the chopping phase angle, and in this case,

a correspondence relationship between ranges for the chopping phase angle and light-adjusting items may be preset. For example, light-adjusting instructions for color adjustment may correspond to the range from 10 degrees to 40 degrees, and within the range, different more specific ranges may be assigned to different colors; light-adjusting instructions for luminance adjustment may correspond to the range from 50 degrees to 80 degrees, and within the rage, different more specific ranges may be assigned to different luminance values. Alternatively, light-adjusting instructions for color adjustment may correspond to the range from 120 degrees to 150 degrees, and within the range, different more specific ranges may be assigned to different colors; light-adjusting instructions for luminance adjustment may correspond to the range from 80 degrees to 110 degrees, and within the range, different more specific ranges may be assigned to different luminance values. And so forth.

(3) light-adjusting items may be differentiated according to both the chopping type and the range for the chopping phase angle, and in this case,

a correspondence relationship between both the chopping type and the range of the chopping phase angle and the light-adjusting item may be preset, e.g., luminance adjustment may correspond to the chopping type and the chopping phase angle range such as leading-edge chopping (10 degrees, 40 degrees) and trailing-edge chopping (120 degrees, 150 degrees). Detailed description is omitted here.

In an extreme case, the range for the chopping phase angle may be a specific angle, and light-adjusting items may be differentiated due to the fact that a specific chopping phase angle is different from a chopping phase angle range. Detailed description is omitted here.

For example, FIG. 3a illustrates leading-edge chopping with a fixed chopping phase angle; FIG. 3b illustrates leading-edge chopping plus trailing-edge chopping with a fixed chopping phase angle; and FIG. 3c illustrates leading-edge chopping with a varying phase angle that ranges within a certain range. The different implementations above of chopping may correspond to different light-adjusting items, which facilitates instructing the driver and transmitting the light-adjusting instruction to the driver.

Step 303: determining a phase angle control strategy of the adjusting switch according to the chopping type and the range for the chopping phase angle.

The phase angle control strategy may include: turn-on time T1 and/or turn-off time T2 of the adjusting switch in a half of the period of the AC power supply, and the order of execution of turning on and turning off in each half period of the AC power supply, where T1<(T/2), T2<(T/2). The turn-on time or the turn-off time of the adjusting switch may be a preset function of the chopping type and/or the range for the chopping phase angle, or may be in a preset correspondence relationship with the chopping type and/or the range for the chopping phase angle. The order of execution of turning on and turning off is related to the chopping type.

Specifically:

(1) if in step 302 the light-adjusting instruction corresponds to the chopping type alone, then in this step the phase angle control strategy is determined according to the chopping type alone, specifically,

the order of execution of turning on and turning off may be determined according to the chopping type. For example, in the case of leading-edge chopping, at each zero-crossing of the AC power supply, the adjusting switch is firstly turned off, and turned on afterwards. The adjusting switch remains turned on until the next zero-crossing of the AC power supply. Hence the order of execution is: turn off first, turn on second. For example, in the case of trailing-edge chopping, at each zero-crossing of the AC power supply, the adjusting switch is firstly turned on, and turned off afterwards. The adjusting switch remains turned off until the next zero-crossing of the AC power supply. Hence the order of execution is: turn on first, turn off second.

With regard to the turn-on time and/or turn-off time, a correspondence relationship between each chopping type and a turn-on time and/or a turn-off time may be set in advance; by searching the correspondence relationship directly according to the chopping type in this step, the turn-on time and/or turn-off time can be determined. For example, the correspondence relationship may include: in each half period of the AC power supply, leading-edge chopping corresponds to the turn-off time of the adjusting switch t1, t1<(T/2), and the turn-on time (T/2)−t1; trailing-edge chopping corresponds to the turn-on time of the adjusting switch t2, t2<(T/2), and the turn-off time (T/2)−t2. The following equation holds for the turn-on time and the turn-off time of a certain adjusting switch in each half period of the AC power supply: turn-on time+turn-off time=(T/2); therefore, a practical application may preset either one of the turn-on time and the turn-off time. The present invention is not limited to the specific implementations.

(2) if in step 302 the light-adjusting instruction corresponds to both the chopping type and the range for the chopping phase angle, then in this step the phase angle control strategy is determined according to both the chopping type and the range for the chopping phase angle in this step, specifically,

the order of execution of turning on and turning off may be determined according to the chopping type, the details of which are omitted here.

The turn-on time and/or turn-off time may be calculated according to the range for the chopping phase angle, and detailed description of the calculation method is omitted.

Step 304: performing chopping-based control on the adjusting switch according to the phase angle control strategy over a preset number, m, of cycles of the AC power supply within a time period NT after receiving the light-adjusting instruction.

Specifically, the chopping-based control may include: chopping in both the positive and negative halves of the period of the AC (as shown in FIGS. 3a to 3c), or chopping in only the positive half or the negative half of the period of the AC power supply (as shown in FIG. 3d). The chopping shown in FIG. 3d may be leading-edge chopping, trailing-edge chopping, or leading-edge plus trailing-edge chopping.

In a practical application, m may be smaller than or equal to N. NT may be a time interval between the reception of the current light-adjusting instruction and the reception of the next light-adjusting instruction. T may be the period of the AC power supply. The time intervals between light-adjusting instructions may be the same or different, hence N may be a constant or a variable, which is not limited in the present invention. Alternatively, NT may be a preset period of chopping-based control; hence, since the reception of the current light-adjusting instruction, chopping-based control may be performed every time period NT until the reception of the next light-adjusting instruction, then, chopping-based control may be performed every time period NT according to the next light-adjusting instruction. In this case, NT has to be smaller than the time interval between adjacent light-adjusting instructions.

The m cycles of the AC power supply for chopping-based control may be the first m cycles of the AC power supply following the reception of the light-adjusting instruction; or may be m cycles of the AC power supply after a certain number of cycles following the reception of the light-adjusting instruction. Clearly, in consideration of the reaction speeds of the light source adjustor and the driver to the light-adjusting instruction, it is preferable to use the first m cycles of the AC power supply following the reception of the light-adjusting instruction as the time period for chopping-based control.

The chopping-based control is to control the adjusting switch according to the phase angle control strategy in the time period mT, so that the light source adjustor outputs a chopped voltage corresponding to the phase angle control strategy.

Furthermore, preferably m is smaller than N, or better, much smaller than N. The reasons are described as follows. The transmission of the light-adjusting instruction is realized as soon as the chopping signal outputted from the light source adjustor is received and detected by the driver. If m is equal to N, the light source adjustor will continually output a chopped voltage during luminance adjustment of the light source, which is similar to the situation in the prior art, and may result in a poor power factor of the light source adjustor, large electromagnetic interference, and resistance matching problems with switched-mode power supplies. Therefore, by outputting the chopped voltage in only the time period mT within the time period NT, the transmission of the light-adjusting instruction can be achieved while reducing the electromagnetic interference and harmonics pollution, and improving the power factors of the light source adjustor and the light source driver.

The control in this step may include:

continually detecting zero-crossing time of the AC power supply, and turning the adjusting switch on or off according to the order of execution of turning on and turning off, with the duration of turning on and the duration of turning off being the turn-on time and the turn-off time respectively.

For example, for leading-edge chopping:

continually detecting zero-crossing time of the AC power supply, turning the adjusting switch off at the zero-crossing time and maintaining for the turn-off time t1, and then turning the adjusting switch on until the next zero-crossing of the AC power supply is detected.

For the trailing-edge chopping:

continually detecting zero-crossing time of the AC power supply, turning the adjusting switch on at the zero-crossing time and maintaining for the turn-on time t2, and then turning the adjusting switch off until the next zero-crossing of the AC power supply is detected.

For leading-edge plus trailing-edge chopping, the control can be implemented according to those described above in the cases of leading-edge chopping and trailing-edge chopping. Detailed description is therefore omitted.

Step 305: controlling the adjusting switch to be turned on during the rest of the time period NT, other than the time period mT, after receiving the light-adjusting instruction.

This step is performed when m is smaller than N, and the voltage outputted from the light source adjustor is the AC power supply voltage when the adjusting switch is turned on.

The order of step 304 and step 305 may be determined according to the location of mT in NT. For example, if chopping-based control is performed in the time period mT right after the reception of the light-adjusting instruction, step 304 is performed before step 305; however, if mT is in the middle of NT, step 305 is performed firstly, then step 304 during the time period mT, and then step 305 again. Clearly, in a practical application, other orders of execution may be used and detailed description is omitted.

By using the method for controlling the light source shown in FIG. 3, adjustment to color and/or luminance can be achieved; moreover, by performing chopping-based control on the adjusting switch in a preset cycles of the AC power supply in NT, electromagnetic interference and harmonics pollution can be reduced, and the power factor of the light source adjustor can be improved. In addition, when the adjusting switch is fully turned on, the loss caused by impedance matching problems between the adjusting switch and subsequent switched-mode power supply-type driver can be reduced.

Corresponding to the method for controlling a light source, the present invention also provides another method for controlling a light source, which is applicable to a light source driver. As shown in FIG. 4, the method includes the following steps.

Step 401: receiving electric energy, detecting a chopped voltage in the electric energy, and determining a chopping type and/or a range for a chopping phase angle.

Step 402: determining a light-adjusting item according to the chopping type and/or the range for the chopping phase angle.

This light-adjusting item corresponds to the light-adjusting item in the light-adjusting instruction. Specifically, correspondingly to the correspondence relationship in the light source adjustor, a correspondence relationship between the chopping type and/or the range for the chopping phase angle and the light-adjusting item may be preset in the driver. Then, in this step, the light-adjusting item indicated in the light-adjusting instruction, i.e., the light-adjusting item to be executed by the driver, can be obtained by searching the correspondence relationship directly according to the chopping type and/or the range for the chopping phase angle.

Step 403: controlling the light source according to the light-adjusting item.

Specifically, this step may be implemented by:

determining an output current according to the light-adjusting item;

generating a corresponding current output to the light source, so as to adjust color and/or luminance of the light source.

By using the method for controlling the light source shown in FIG. 4, the chopping type and/or the range for the chopping phase angle of the chopped voltage is detected from the received electric energy, the light-adjusting item is determined according to the chopping type and/or the range for the chopping phase angle, and the light source is controlled accordingly, thereby realizing color and/or luminance adjustment of the light source by the driver.

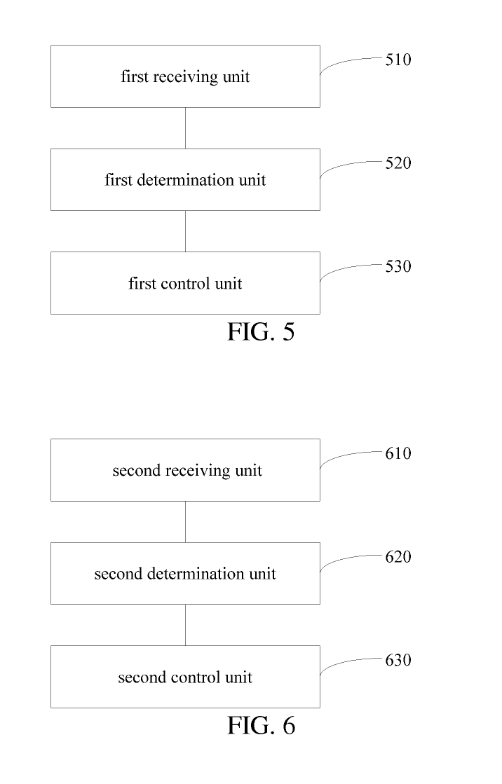

Correspondingly to the method for controlling a light source, an embodiment of the present invention provides an apparatus for controlling a light source, which can be provided in a light source adjustor and control an adjusting switch in the light source adjustor. As shown in FIG. 5, the apparatus includes:

a first receiving unit 510, for receiving a light-adjusting instruction and determining a light-adjusting item instructed by the light-adjusting instruction;

a first determination unit 520, for determining, according to the light-adjusting item, a chopping type and/or a range for a chopping phase angle corresponding to the light-adjusting item;

a first control unit 530, for controlling the adjusting switch according to the chopping type and/or the range for the chopping phase angle, so as to output electric energy including a chopped voltage.

Preferably, the first determination unit may include:

a relationship storage sub-unit, for storing a preset correspondence relationship between the chopping type and/or the range for the chopping phase angle and the light-adjusting item;

a searching sub-unit, for searching the correspondence relationship for the chopping type and/or the range for the chopping phase angle corresponding to the light-adjusting item according to the light-adjusting item.

Preferably, the first control unit 530 may include:

a first determination sub-unit, for determining a phase angle control strategy according to the chopping type and/or the range for the chopping phase angle;

a control sub-unit, for controlling the adjusting switch according to the phase angle control strategy.

Specifically, the first control unit 530 may be used for: performing chopping-based control on the adjusting switch for a time period mT within a time period NT after the reception of the light-adjusting instruction, where mT<NT; m is a preset constant; T is the period of an AC power supply; and NT is a time interval between receiving the current light-adjusting instruction and receiving the next light-adjusting instruction.

In this case, the first control unit 530 may further be used for:

controlling the adjusting switch to be turned on during the rest of the time period NT, other than the time period mT, after the reception of the light-adjusting instruction.

When the first control unit 530 is implemented with the first determination sub-unit and the control sub-unit, the control sub-unit may be used for performing chopping-based control on the adjusting switch according to the phase angle control strategy for the time period mT within the time period NT after the reception of light-adjusting instruction; and may further be used for controlling the adjusting switch to be turned on during the rest of the time period NT, other than the time period mT, after the reception of the light-adjusting instruction.

The light-adjusting item may include: adjustment to color and/or luminance, and/or a level of the adjustment to luminance.

As shown in FIG. 6, an embodiment of the present invention provides another apparatus for controlling a light source, which can be provided in a driver. The apparatus includes:

a second receiving unit 610, for receiving electric energy including a chopped voltage, detecting a chopping type and/or a range for a chopping phase angle of the chopped voltage;

a second determination unit 620, for determining a light-adjusting item according to the chopping type and/or the range for the chopping phase angle;

a second control unit 630, for controlling the light source according to the light-adjusting item.

Preferably, the second control unit 630 may include:

a second determination sub-unit, for determining an output current according to the light-adjusting item;

a generation sub-unit, for generating a corresponding current output to the light source, so as to perform a control instructed by the light-adjusting item on the light source.

The light-adjusting item may include: adjustment to color and/or luminance, and/or a level of the adjustment to luminance.

Furthermore, an embodiment of the present invention provides a light source control system, including:

a light source adjustor, for receiving a light-adjusting instruction, and determining a light-adjusting item instructed by the light-adjusting instruction; determining, according to the light-adjusting item, a chopping type and/or a range for a chopping phase angle corresponding to the light-adjusting item; and controlling an adjusting switch according to the chopping type and/or the range for the chopping phase angle, so as to output electric energy including a chopped voltage;

a driver, for receiving the electric energy including the chopped voltage, detecting the chopping type and/or the range for the chopping phase angle of the chopped voltage; determining the light-adjusting item according to the chopping type and/or the range for the chopping phase angle; and controlling the light source according to the light-adjusting item.

By using the above apparatuses and system for controlling a light source, in the light source adjustor, the corresponding chopping type and/or the range for the chopping phase angle are determined according to the light-adjusting item instructed by the light-adjusting instruction, and the adjusting switch is controlled according to the chopping type and/or the range for the chopping phase angle, so that a chopped voltage is included in the electric energy outputted from the light source adjustor. Then, the light-adjusting item is instructed to the driver via the chopped voltage, which facilitates the driver controlling the light source on its color and/or luminance as instructed by the light-adjusting item.

It shall be understood by those skilled in the art that the above light source control methods according to the embodiments can be implemented by a program instructing related hardware. The program may be stored in a readable medium, and the program, when executed, may execute the corresponding steps of the above methods. The storage medium may be ROM/RAM, a magnetic disk, an optical disc, etc.

Preferable embodiments of the present invention are described above. It should be noted that those skilled in the art can make modifications and alternations without deviation from the principle of the present invention, and the modifications and alternations shall fall within the scope of the present invention.

1. A method for controlling a light source, comprising:
receiving a light-adjusting instruction, and determining a light-adjusting item instructed by the light-adjusting instruction;
determining, according to the light-adjusting item, a chopping type and/or a range for a chopping phase angle corresponding to the light-adjusting item; and
controlling an adjusting switch according to the chopping type and/or the range for the chopping phase angle, so as to output electric energy comprising a chopped voltage.

2. The method according to claim 1, wherein the determining the chopping type and/or the range for the chopping phase angle corresponding to the light-adjusting item according to the light-adjusting item comprises:
presetting a correspondence relationship between the chopping type and/or the range for the chopping phase angle and the light-adjusting item; and
searching, according to the light-adjusting item, the correspondence relationship for the chopping type and/or the range for the chopping phase angle corresponding to the light-adjusting item.

3. The method according to claim 1, wherein the controlling the adjusting switch according to the chopping type and/or the range for the chopping phase angle comprises:
determining a phase angle control strategy of the adjusting switch according to the chopping type and/or the range for the chopping phase angle; and
controlling the adjusting switch according to the phase angle control strategy.

4. The method according to claim 1, wherein the controlling the adjusting switch comprises: performing chopping-based control on the adjusting switch for a time period mT within a time period NT after receiving the light-adjusting instruction, where mT<NT; m is a preset constant; T is the period of an alternating current (AC) power supply; and NT is a time interval between receiving the current light-adjusting instruction and receiving the next light-adjusting instruction, or is a preset period of chopping-based control.

5. The method according to claim 4, further comprising: controlling the adjusting switch to be turned on during the rest of the time period NT, other than the time period mT, after receiving the light-adjusting instruction.

6. The method according to claim 1, wherein the light-adjusting item comprises: adjustment to color and/or luminance, and/or a level of the adjustment to luminance.

7. A method for controlling a light source, comprising:
receiving electric energy comprising a chopped voltage, and detecting a chopping type and/or a range for a chopping phase angle of the chopped voltage;
determining a light-adjusting item according to the chopping type and/or the range for the chopping phase angle;
controlling the light source according to the light-adjusting item.

8. The method according to claim 7, wherein the controlling the light source according to the light-adjusting item comprises:
determining an output current according to the light-adjusting item;
generating a corresponding current output to the light source, so as to control the light source as instructed by the light-adjusting item.

9. The method according to claim 7, wherein the light-adjusting item comprises: adjustment to color and/or luminance, and/or a level of the adjustment to luminance.

10. An apparatus for controlling a light source, comprising:
a first receiving unit, for receiving a light-adjusting instruction and determining a light-adjusting item instructed by the light-adjusting instruction;
a first determination unit, for determining according to the light-adjusting item a chopping type and/or a range for a chopping phase angle corresponding to the light-adjusting item;
a first control unit, for controlling an adjustment switch according to the chopping type and/or the range for the chopping phase angle, so as to output electric energy comprising a chopped voltage.

11. The apparatus according to claim 10, wherein the first determination unit comprises:
a relationship storage sub-unit, for storing a preset correspondence relationship between the chopping type and/or the range for the chopping phase angle and the light-adjusting item; and
a searching sub-unit, for searching, according to the light-adjusting item, the correspondence relationship for the chopping type and/or the range for the chopping phase angle corresponding to the light-adjusting item.

12. The apparatus according to claim 10, wherein the first control unit comprises:
a first determination sub-unit, for determining a phase angle control strategy of the adjusting switch according to the chopping type and/or the range for the chopping phase angle;
a control sub-unit, for controlling the adjusting switch according to the phase angle control strategy.

13. The apparatus according to claim 10, wherein the first control unit is used for: performing chopping-based control on the adjusting switch for a time period mT within a time period NT after receiving the light-adjusting instruction, where mT<NT; m is a preset constant; T is the period of an alternating current (AC) power supply; and NT is a time interval between receiving the current light-adjusting instruction and receiving the next light-adjusting instruction, or is a preset period of chopping-based control.

14. The apparatus according to claim 13, wherein the first control unit is further used for:
controlling the adjusting switch to be turned on during the rest of the time period NT, other than the time period mT, after receiving the light-adjusting instruction.

15. The apparatus according to claim 10, wherein the light-adjusting item comprises: adjustment to color and/or luminance, and/or a level of the adjustment to luminance.

16. An apparatus for controlling a light source, comprising:
a second receiving unit, for receiving electric energy comprising a chopped voltage, and detecting a chopping type and/or a range for a chopping phase angle of the chopped voltage;
a second determination unit, for determining a light-adjusting item according to the chopping type and/or the range for the chopping phase angle;
a second control unit, for controlling the light source according to the light-adjusting item.

17. The apparatus according to claim 16, wherein the second control unit comprises:
a second determination sub-unit, for determining an output current according to the light-adjusting item;
a generation sub-unit, for generating a corresponding current output to the light source, so as to control the light source as instructed by the light-adjusting item.

18. The apparatus according to claim 16, wherein the light-adjusting item comprises: adjustment to color and/or luminance, and/or a level of the adjustment to luminance.

19. A system for controlling a light source, comprising:
a light source adjustor, for receiving a light-adjusting instruction, and determining a light-adjusting item instructed by the light-adjusting instruction; determining, according to the light-adjusting item, a chopping type and/or a range for a chopping phase angle corresponding to the light-adjusting item; and controlling an adjusting switch according to the chopping type and/or the range for the chopping phase angle, so as to output electric energy comprising a chopped voltage;
a driver, for receiving the electric energy comprising the chopped voltage, detecting the chopping type and/or the range for the chopping phase angle of the chopped voltage; determining the light-adjusting item according to the chopping type and/or the range for the chopping phase angle; and controlling the light source according to the light-adjusting item.
